(19) United States
(12) Patent Application Publication
(10) Pub. No.: US 2020/0301239 A1
(43) Pub. Date: Sep. 24, 2020

(54) VARIFOCAL DISPLAY WITH FIXED-FOCUS LENS

(71) Applicant: Microsoft Technology Licensing, LLC, Redmond, WA (US)

(72) Inventors: Onur Can AKKAYA, Palo Alto, CA (US); Bernard Charles KRESS, Redwood City, CA (US); Sergio ORTIZ EGEA, San Jose, CA (US); Alfonsus D. LUNARDHI, San Ramon, CA (US)

(73) Assignee: Microsoft Technology Licensing, LLC, Redmond, WA (US)

(21) Appl. No.: 16/357,176

(22) Filed: Mar. 18, 2019

(51) Int. Cl. G02F 1/29; G02B 27/01

(52) U.S. Cl. CPC G02F 1/29; G02B 2027/0178; G02F 2001/294; G02B 27/0172

(57) ABSTRACT

A near-eye display system comprises a display projector configured to emit display light, an optical waveguide, a fixed-focus lens, and a variable-focus lens of variable optical power. The optical waveguide is configured to receive the display light and to release the display light toward an observer. The fixed-focus lens is arranged to adjust a vergence of the display light released from the optical waveguide. The variable-focus lens is arranged in series with the fixed-focus lens and configured to vary, responsive to a focusing bias, the vergence of the display light released from the optical waveguide.

### BACKGROUND

In recent years, near-eye display technology has transitioned from niche status into an emerging consumer technology. Implemented primarily in head-worn display devices, near-eye display technology enables 3D stereo vision and virtual reality (VR) presentation. When implemented with see-through optics, it enables a mixed reality (MR), in which VR elements are admixed into the user's natural field of view. Despite these benefits, near-eye display technology faces numerous technical challenges. Such challenges include accurate stimulation of the oculomotor depth cues that enable human depth perception.

### SUMMARY

One embodiment is directed to a near-eye display system comprising a display projector configured to emit display light, an optical waveguide, a fixed-focus lens, and a variable-focus lens of variable optical power. The optical waveguide is configured to receive the display light and to release the display light toward an observer. The fixed-focus lens is arranged to adjust a vergence of the display light released from the optical waveguide. The variable-focus lens is arranged in series with the fixed-focus lens and configured to vary, responsive to a focusing bias, the vergence of the display light released from the optical waveguide.

This Summary is provided to introduce in a simplified form a selection of concepts that are further described in the Detailed Description below. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an example implementation environment for a near-eye display system.

FIGS. 2A and 2B show additional aspects of example near-eye display systems.

FIGS. 3 and 4 illustrate the effect of stereo disparity on virtual-image display in a near-eye display system.

FIGS. 5, 6, and 7 show aspects of example liquid-crystal based spatial light modulators.

FIGS. 8 and 9 shows aspects of other example near-eye display systems.

FIG. 10 shows aspects of an example optical waveguide usable with the near-eye display system of FIG. 9

FIG. 11 illustrates the estimation of a user's pupil positions in connection to virtual-image display in a near-eye display system.

### DETAILED DESCRIPTION

In order to display virtual imagery with life-like three-dimensionality, a near-eye display system must stimulate one or more depth cues of the human visual system. Some near-eye display systems apply stereo disparity to virtual imagery focused on a fixed plane. That approach stimulates only the binocular-vergence depth cue, but fails to stimulate the equally important accommodation cue, whereby the observer's crystalline lens changes shape to focus on imagery at different depths. Stimulation of one depth cue while neglecting others may create a dissonance that results in observer discomfort.

To remedy that effect, the disclosure herein presents near-eye display implementations that apply stereo disparity to virtual imagery focused on a movable focal plane, thereby stimulating both binocular-vergence and accommodation depth cues. These display systems employ tunable lenses arranged in series with fixed-power lenses, which enable the tunable lenses to be used under a restricted range of operating conditions, for improved performance. Potential performance improvements depend on the implementation, and may include larger aperture size, better modulation-transfer function (MTF), and lower power consumption. In see-through implementations, the near-eye display systems include complementary pairs of fixed-power and tunable lenses, so that external imagery is passed unmagnified and undistorted to the observer.

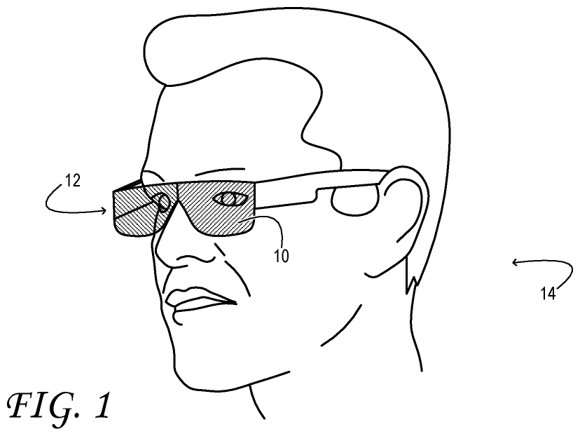

FIG. 1 shows aspects of an example implementation environment for a near-eye display system 10A. As illustrated herein, the near-eye display system is a component of wearable electronic device 12, which is worn and operated by user 14. The near-eye display system is configured to present virtual imagery in the user's field of view. In some implementations, user-input componentry of the wearable electronic device may enable the user to interact with the virtual imagery. Wearable electronic device 12 takes the form of eyeglasses in the example of FIG. 1. In other examples, the wearable electronic device may take the form of goggles, a helmet, or a visor. In still other examples, the near-eye display system may be a component of a non-wearable electronic device.

Near-eye display system 10A may be configured to cover one or both eyes of user 14 and may be adapted for monocular or binocular image display. In examples in which the near-eye display system covers only one eye, but binocular image display is desired, a complementary near-eye display system may be arranged over the other eye. In examples in which the near-eye display system covers both eyes and binocular image display is desired, the virtual imagery presented by near-eye display system 10A may be divided into right and left portions directed to the right and left eyes, respectively. In scenarios in which stereoscopic image display is desired, the virtual imagery from the right and left portions, or complementary near-eye display systems, may be configured with appropriate stereo disparity (vide infra) so as to present a three-dimensional subject or scene.

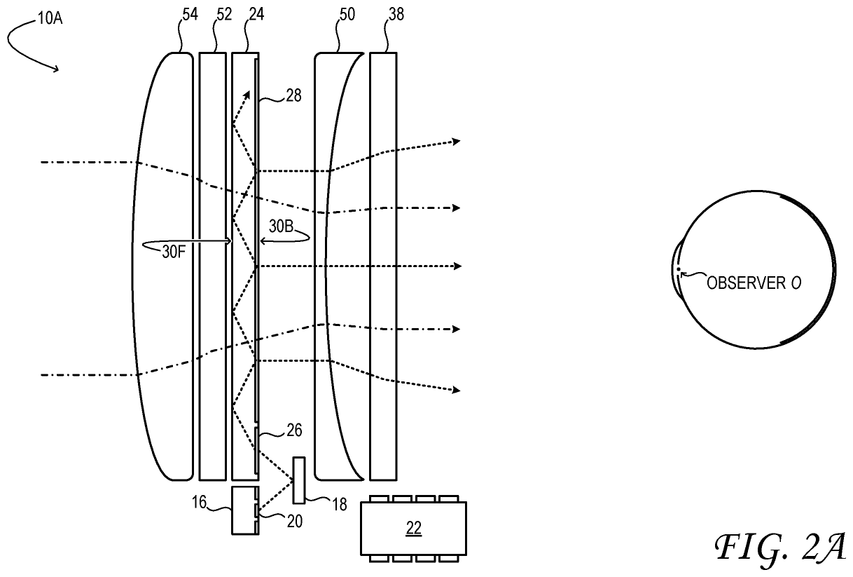

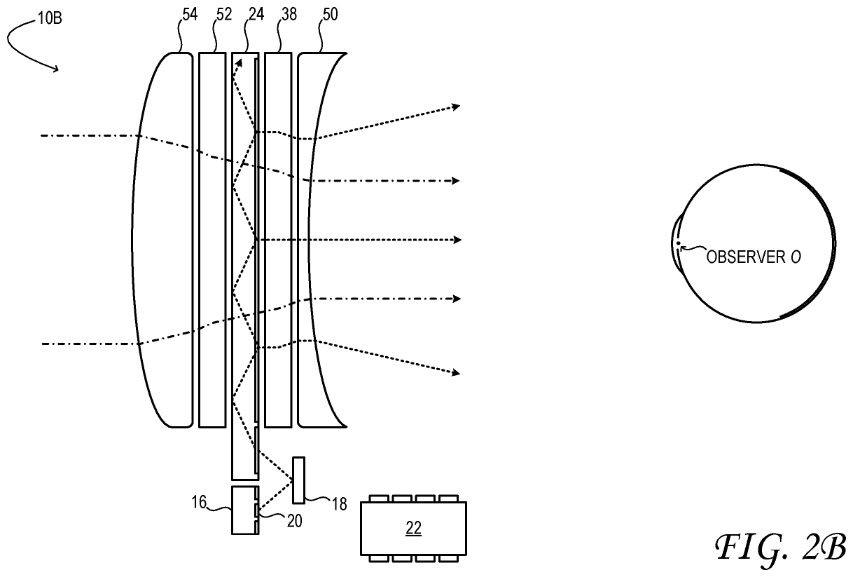

FIGS. 2A and 2B show aspects of example near-eye display systems. Turning first to FIG. 2A, near-eye display system 10A includes a display projector 16 configured to emit display light. The display projector of FIG. 2A includes a high-resolution spatial light modulator (SLM) 18 illuminated by one or more light emitters 20. The light emitters may comprise light-emitting diodes (LEDs) or laser diodes, and the SLM may comprise a liquid-crystal-on-silicon (LCOS) or digital micromirror array, for example. The SLM and the light emitters of the display projector are coupled operatively to display controller 22. The display controller controls the matrix of independent, light-directing pixel elements of the SLM so as to cause the SLM to modulate the light received from the light emitters and thereby form the desired display image. By controlling the light modulation temporally as well as spatially, the display controller may cause the display projector to project a synchronized sequence of display images (i.e., video). In the example shown in FIG. 2A, the display image is formed by reflection from the SLM. In other examples, a display image may be formed by transmission through a suitably configured, transmissive SLM. Display projectors based on other technologies are also envisaged-organic LED arrays, raster-scanning laser beams, etc.

Near-eye display system 10A includes at least one optical waveguide 24 configured to receive the display light from display projector 16 and to release the display light toward observer O. The term ‘observer’ refers herein to the optical vantage point of user 14 of the electronic device in which the near-eye display system is installed. In some examples, the observer O may correspond to a head, eye, or pupil position of the user.

In the illustrated example, optical waveguide 24 includes an entry grating 26 and an exit grating 28. Entry grating 26 is a diffractive structure configured to receive the display light and to couple the display light into the optical waveguide. After coupling into the optical waveguide, the display light propagates through the optical waveguide by total internal reflection (TIR) from front and back faces 30F and 30B of the optical waveguide. Exit grating 28 is a diffractive structure configured to controllably release the propagating display light from the optical waveguide in the direction of observer O. To this end, the exit grating includes a series of light-extraction features of varying strength. The light-extraction features of the exit grating may be arranged from weak to strong in the direction of display-light propagation through the optical waveguide, so that the display light is released at uniform intensity over the length of the exit grating. In this manner, optical waveguide 24 is configured to expand the exit pupil of display projector 16 so as to fill or slightly overfill the eyebox of user 14. This condition provides desirable image quality and user comfort.

In some examples, optical waveguide 24 may expand the exit pupil of display projector 16 in one direction only—e.g., the horizontal direction, in which the most significant eye movement occurs. Here, the display projector itself may offer a large enough exit pupil—natively, or by way of a vertical pre-expansion stage—so that vertical expansion within the optical waveguide is not necessary. In other examples, however, optical waveguide 24 may be configured to expand the exit pupil of the display projector in the horizontal and vertical directions. In such examples, display light propagating in a first direction within the optical waveguide may encounter a turning grating (not shown in FIG. 2A) having a plurality of diffraction features arranged weak to strong in the first direction. The turning grating may be configured such that the light diffracted by the diffraction features is reflected 90° so as to propagate in a perpendicular second direction, having now been expanded in the first direction. Parallel rays of the expanded light then encounter exit grating 28 and are out-coupled from the waveguide as described above.

Continuing, each display image formed by near-eye display system 10A is a virtual image presented at a predetermined distance Z₀ in front of observer O. The distance Z₀ is also referred to as the ‘depth of the focal plane’ of the display image. In some near-eye display configurations, the value of Z₀ is a fixed function of the design parameters of display projector 16, entry grating 26, exit grating 28, and/or other fixed-function optics. Based on the permanent configuration of these structures, the focal plane may be positioned at a desired depth—at infinity, at 300 centimeters (cm), or at 200 cm, for example.

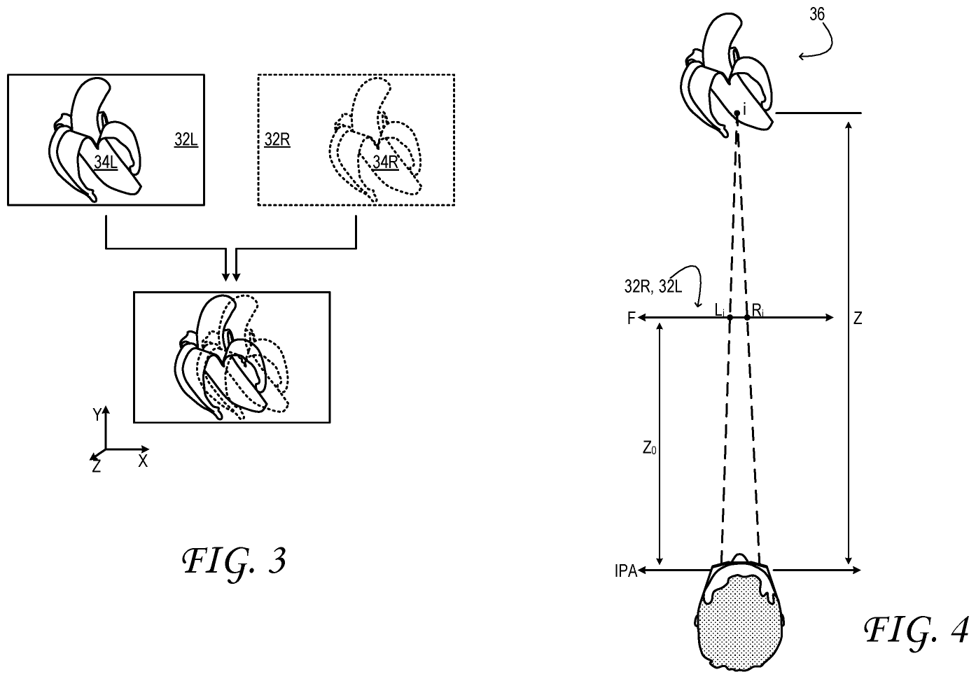

A stereoscopic near-eye display system employing a fixed focal plane may be capable of presenting virtual-display imagery perceived to lie at a controlled, variable distance in front of, or behind, the fixed focal plane. This effect can be achieved by controlling the horizontal disparity of each pair of corresponding pixels of the right and left stereo images. Usable also to impart three-dimensionality to a virtual display image, this approach will be understood with reference to FIGS. 3 and 4.

FIG. 3 shows right and left image frames 32R and 32L, overlaid upon each other for purpose of illustration. The right image frame encloses right display image 34R, and the left image frame encloses left display image 34L. Viewed concurrently through a stereoscopic near-eye display device, the right and left display images may appear to the observer as virtual imagery. In the example of FIG. 3, the virtual imagery presents a viewable surface of individually rendered loci.

With reference to FIG. 4, each locus i of the viewable surface has a depth coordinate Zᵢ associated with each pixel (Xᵢ, Yᵢ) of the right and left display images. The desired depth coordinate may be simulated as follows. At the outset, a distance Z₀ to a focal plane F of the stereoscopic near-eye display system is chosen. As noted above, the optical componentry of the stereoscopic near-eye display system may be configured to present each display image at a vergence appropriate for the chosen distance. In one example, Z₀ may be set to ‘infinity’, so that each optical system presents a display image in the form of collimated light rays. In another example, Z₀ may be set to 200 cm, requiring the optical system to present each display image in the form of diverging light. In some examples, Z₀ may be chosen at design time and remain unchanged for all virtual imagery presented by the display system. Alternatively, the optical systems may be configured with electronically adjustable optical power, to allow Z₀ to vary dynamically according to the range of distances over which the virtual imagery is to be presented.

Once the distance Z₀ to the focal plane has been established, the depth coordinate Z for every locus i on the viewable surface may be set. This is done by adjusting the positional disparity of the two pixels corresponding to locus i in the right and left display images relative to their respective image frames. In FIG. 4, the pixel corresponding to locus i in the right image frame is denoted Rᵢ, and the corresponding pixel of the left image frame is denoted Lᵢ. In FIG. 4, the positional disparity is positive—i.e., Rᵢ is to the right of Lᵢ in the overlaid image frames. Positive positional disparity causes locus i to appear behind focal plane F. If the positional disparity were negative, the locus would appear in front of the focal plane. Finally, if the right and left display images were superposed (no disparity, Rᵢ and Lᵢ coincident) then the locus would appear to lie directly on the focal plane. Without tying this disclosure to any particular theory, the positional disparity D may be related to Z, Z₀, and to the interpupilary distance (IPD) of the observer by

$$D = IPD \times ( 1 - \frac{{Z}_{0}}{Z} ) .$$

In the approach described above, the positional disparity sought to be introduced between corresponding pixels of the right and left display images is ‘horizontal’ disparity—viz., disparity parallel to the interpupilary axis of the observer. Horizontal disparity partially mimics the effect of real-object depth on the human visual system, where images of a real object received in the right and left eyes are naturally offset parallel to the interpupilary axis.

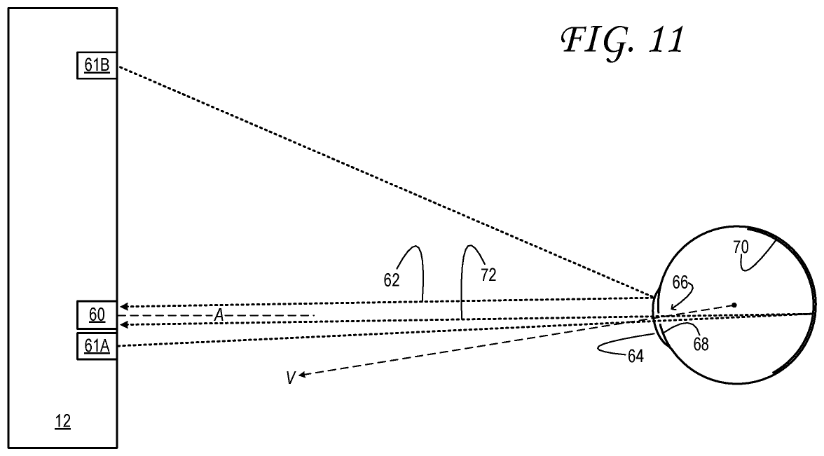

In one implementation, logic in display controller 22 maintains a model of the Cartesian space in front of the observer, in a frame of reference fixed to near-eye display system 10A. The observer's pupil positions are mapped onto this space, as are the image frames 32R and 32L, each positioned at the predetermined depth Z₀. Then, virtual imagery 36 is constructed, with each locus i of the viewable surface of the imagery having coordinates Xᵢ, Yᵢ, and Zᵢ, in the common frame of reference. For each locus of the viewable surface, two-line segments are constructed—a first line segment to the pupil position of the observer's right eye and a second line segment to the pupil position of the observer's left eye. The pixel Rᵢ of the right display image, which corresponds to locus i, is taken to be the intersection of the first line segment in right image frame 32R. Likewise, the pixel Lᵢ of the left display image is taken to be the intersection of the second line segment in left image frame 32L. This procedure automatically provides the appropriate amount of shifting and scaling to correctly render the viewable surface, placing every locus i at the required distance from the observer. In some examples, the approach outlined above may be facilitated by real-time estimation of the observer's pupil positions. That variant is described hereinafter, with reference to FIG. 11. In examples in which pupil estimation is not attempted, a suitable surrogate for the pupil position, such as the center of rotation of the pupil position, or eyeball position, may be used instead.

Returning now to FIG. 2A, controlling the stereo disparity of images confined to a fixed focal plane is appropriate for rendering a three-dimensional effect, but it is less appropriate for shifting an entire display image back and forth in the observer's field of view. The reason is related to the mechanism by which a human being perceives depth. To resolve depth in a complex scene, the human visual cortex interprets plural visual cues (e.g., occlusion and motion parallax), in addition to the neurologically coupled, oculomotor cues of binocular vergence and crystalline-lens accommodation. Stereo disparity correctly stimulates the binocular-vergence cue but does not stimulate the accommodation cue. Rather, the observer's crystalline lenses remain focused on the fixed focal plane no matter the depth value indicated by the stereo disparity. When the disparity changes, but the focal plane does not move, a dissonance is perceived between the two oculomotor cues. Referred to as vergence-accommodation conflict (VAC), this dissonance may result in user discomfort.

To address this issue, near-eye display system 10A of FIG. 2A is configured to vary the focal plane on which virtual display imagery is presented in order to lessen the experience of VAC. To this end, the near-eye display system includes a variable-focus lens 38 of variable optical power. The variable-focus lens is configured to vary, responsive to a focusing bias, the vergence of the display light released from optical waveguide 24. Display controller 22 is configured to control the focusing bias such that the display light is imaged onto a focal plane positioned at a controlled, variable distance from observer O. In stereoscopic near-eye display systems, this control feature may be enacted in combination with appropriate control of the stereo disparity, as described above.

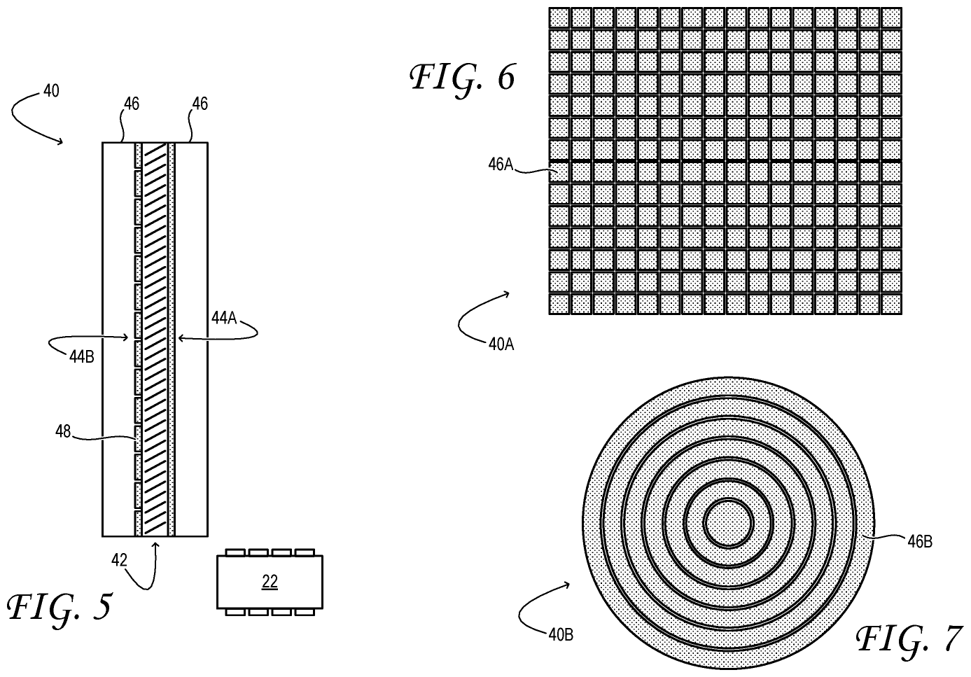

Variable-focus lens 38 may comprise a transmissive liquid-crystal SLM—i.e., LCSLM—operatively coupled to display controller 22. FIG. 5 shows, in cross section, aspects of example LCSLM configurations consonant with this disclosure. LCSLM 40 includes a thin layer of nematic liquid crystal (LC) 42 sandwiched between transparent electrode coatings 44A and 44B. Each transparent electrode coating may comprise a highly doped semiconductor material (e.g., indium tin oxide) arranged on a transparent, dielectric substrate 46. Electrode coating 44A may span its substrate, but electrode coating 44B may be segmented, so as to form individual microelectrodes 48, which are independently addressable by display controller 22.

By varying controllably the bias applied to each microelectrode 48, display controller 22 can control the electric field vector between each microelectrode and electrode coating 44A. The electric field vector at each independently controlled microelectrode influences the orientation of LC molecules in the space between that microelectrode and electrode coating 44A, which, in turn, influences the retardance of the light transmitted therethrough. In this manner, the retardance profile over the entire physical aperture of LCSLM 40 can be programmed and reprogrammed as desired. The retardance profile may be programmed to simulate the optical function of an elementary refractive lens, for example, or a Fresnel lens. Neither the density nor the topology of the microelectrode structure of electrode coating 44B is limited in any way, except by suitability to the expected application. In some examples, the LCSLM may have a rectangular, pixilated microelectrode cell structure, as represented by microelectrodes 46A of LCSLM 40A, in FIG. 6. In other examples, the microelectrodes may take the form of narrow bands or narrow, concentric rings, as represented by microelectrodes 46B of LCSLM 40B, in FIG. 7.

In still other examples, variable-focus lens 38 may be based on an alternative technology. As nonlimiting examples, an electrowetting, elastomeric-membrane, or mechanically actuated lens may be used in place of the LC-based variable-focus lens described above.

Returning now to FIG. 2A, it is convenient in some examples to configure display projector 16, entry grating 26, and exit grating 28 so as to release a collimated display image from optical waveguide 24. Without any external focusing applied, such a display image would appear to observer O to originate at infinity. Shifting the display image to a close focal plane of 33 cm would require optical power of about −3 diopters (D). Although variable-focus lens 38 could be used to impart such optical power, there is a disadvantage in using the variable-focus lens for that particular operation.

In general, it is desirable for variable-focus lens 38 to achieve a parabolic phase profile over its entire tunable range and low distortion and chromatic aberration over its entire angular range. The variable-focus lens should also exhibit high optical transmission and minimum scattering, a high Strehl ratio, and a near diffraction-limited modulation transfer function (MTF). Of these features, the parabolic phase profile can be the most challenging to achieve. The refractive-index profile that determines the phase profile in an LC lens is established by the orientation of the LC molecules therein. Modulation of the molecular orientation is achieved by controlling the analog voltage distribution applied to discrete microelectrodes—e.g., pixel electrodes for reconfigurable phase elements, ring electrodes for rotationally symmetric lenses, or linear electrodes for cylindrical lenses. Although the electric field can be well defined in regions adjacent to the microelectrodes, the regions between the microelectrodes may exhibit phase variations that degrade the diffraction-limited performance of the lens.

As the phase difference between adjacent regions is proportional to the applied voltage, keeping the voltage difference between any two microelectrodes the same would yield a near-parabolic phase profile. A linear voltage drop between microelectrodes could be achieved, for example, by using resistors as voltage dividers. However, at high optical power, the voltage drops to zero over a fewer number of microelectrodes, thereby reducing the aperture of the lens. In other words, the active aperture is smaller at higher optical power levels. In a near-eye-display application this becomes a limitation, because it is desirable for the exit pupil to be large enough to support rotations and movements of the eye and to provide a comfortable user experience.

Another issue is the finite phase retardation one can imprint through a typical LC layer at desirable voltages, which is linked to the finite birefringence one can achieve with a thin LC layer. This factor also limits the aperture of any lens (pure refractive, Fresnel or diffractive) that may be implemented in a tunable LC layer.

In view of the analysis above, it is desirable to limit the absolute optical power (i.e., the absolute value of the optical power) of variable-focus lens 38 to the lowest practicable value, and thereby secure the largest aperture and best optical quality. The solution herein is to further shift the optical power applied to the display image by a fixed amount, which combines additively with the variable optical power of the variable-focus lens. Accordingly, near-eye display system 10A of FIG. 2A includes a fixed-focus lens 50 in series with variable-focus lens 38 and arranged to adjust a vergence of the display light released from optical waveguide 24. In some examples, the fixed-focus lens may be an elementary refractive or Fresnel lens having a relatively large aperture. In some examples, the fixed-focus lens is a polymerized LC lens, which can be coupled straightforwardly to LC-based variable-focus lens 38, in an optical stack of reduced thickness.

In the configuration of FIG. 2A, fixed-focus lens 50 is positioned between variable-focus lens 38 and optical waveguide 24. In the configuration of FIG. 2B, the variable-focus lens may be positioned between the fixed-focus lens and the optical waveguide, with no effect on the principle of operation. In some examples, direct coupling between the flat face 30B of the optical waveguide and the flat face of the variable-focus lens may provide an advantage in manufacture and may reduce the overall thickness of the optical stack.

In some examples, fixed-focus lens 50 may impart a substantial divergence to the display image released from optical waveguide 24, so that without any optical power contributed by variable-focus lens 38, the display image is presented at a close focal plane (e.g., 33 cm). Accordingly, image quality in the most demanding state for human vision may be determined primarily by the fixed-focus lens, which may exhibit near diffraction-limited optical performance with minimal aberration, scattering, etc. Further, the clear aperture of the fixed-focus lens is not limited by its optical power, as is the variable-focus lens. Rather, the fixed-focus lens supports a large exit pupil that can accommodate large movements and rotations of the eye. Moreover, this arrangement offers reduced power consumption in what is expected to be a typical usage scenario—viz., a depth of about one arm's length for the display image—as the variable-focus lens would be inactive in that region.

In this configuration, when the display image is to be presented at a farther focal plane—e.g., at infinity—variable-focus lens 38 may be energized so as to offset or reverse the divergence effected by fixed-focus lens 50. Although the highly energized variable-focus lens may suffer a reduction in aperture size, etc., the various nonidealities will be less noticeable observing the distant image. For instance, optical power of +3 D may be required of the variable-focus lens to shift the focal plane back out to infinity. This may be a challenging optical state for the variable focus lens because of the high absolute optical power. Assuming, however, that the angular resolution of the eye (e.g., about 1 arcmin) is independent of distance, the ability to resolve spatial features will naturally decrease with increasing distance. Furthermore, the small aperture of the tunable lenses at high absolute optical power is acceptable, as the movements and rotations of the eye are expected to be lowest in this region.

Accordingly, variable-focus lens 38 may be configured such that its optical power varies within a non-divergent, non-negative diopter range as a function of the focusing bias. For example, the optical power of the variable-focus lens may vary between 0 and +3 D. A variable-focus lens configured for this range of optical power may be arranged in series with a fixed-focus lens 50 of −3 D. More generally, the optical power of the variable-focus lens at the maximum value of the non-negative diopter range may oppose and substantially reverse the optical power of the fixed-focus lens, to achieve focus at infinity. The term ‘substantially’ is used herein to acknowledge inevitable manufacturing tolerances in components designed to provide equal and opposite optical power.

In other examples, the maximum optical power of the variable-focus lens may not fully reverse the static power shift of the fixed-focus lens, so that only finite far-field focus is achievable. In other words, the combined optical power need not start or stop at 0 D (with the focal plane at infinity), but rather at a preferred optical power for near-eye display system 10A. The preferred optical power may be −0.5 D, for example, such that the far-field image rests at 200 cm rather than infinity, for more comfortable viewing. One way to achieve this result is to keep the optical power of the fixed-focus lens at −3 D but operate the variable-focus lens in a range of 0 to +2.5 D.

In other examples, the variable optical power of variable-focus lens 38 may vary from a divergent, negative diopter value to a convergent, positive diopter value as a function of the focusing bias. In series with a fixed-focus lens of −1.5 D, a variable-focus lens operated between −1.5 to +1.5 D would provide a combined −3 to 0 D tunable range. In series with a fixed-focus lens of −1.75 D, a variable-focus lens operated between −1.25 to +1.25 D would provide a combined −3.0 to −0.5 D tunable range. Presented by way of example, these variants are attractive in part because the aperture of an LC lens (elementary refractive or Fresnel) is equally affected by positive and negative optical power of the same magnitude. Accordingly, the nonideality experienced at the maximum divergent power of the combined system could be no worse than that of a variable-focus lens operated at half of the combined optical power. Moreover, the nonideality experienced at the minimum divergence would be greatly reduced.

Accordingly, the maximum absolute optical power of variable-focus lens 38 may not fully offset the optical power shift of fixed-focus lens 50, but may approach a lower absolute level, such that the variable-focus lens is operated over a symmetric or asymmetric optical power range to achieve the desired range of combined optical power.

In some examples, wearable electronic device 12 is opaque, such that user 14 can see only the virtual imagery provided via near-eye display system 10A. In other examples, the near-eye display system may be used in a device or environment that also allows external imagery to reach the user. Such an environment may be referred to as an ‘augmented-reality’ (AR) or ‘mixed-reality’ (MR) environment. Applied in such an environment, variable-focus lens 38 and/or fixed-focus lens 50 of near-eye display system 10A would alter the vergence of the external light received from opposite the observer (i.e., the external light reflecting off of real world objects in the environment, through the near-eye display system, and to the observer's eye). In general, any near-eye display system that applies optical power to imagery perceived by the user desirably can, when operated in an AR or VR environment, apply compensatory optical power to the external imagery. Otherwise the external imagery would appear magnified.

To address this issue in AR and VR environments, a near-eye display system may incorporate fixed and/or tunable lenses on the world-facing side of the waveguide to compensate for the focal power introduced by the fixed and/or tunable lenses on the observer-facing side. Here, the optical power effected by the observer-facing lenses is compensated by synchronous change in the optical power of the world-facing lenses. This configuration provides unmagnified and undistorted viewing of real-world imagery superposed on virtual imagery of the desired magnification.

In FIG. 2A, accordingly, where optical waveguide 24 is configured to receive external light from opposite observer O and to release the external light toward the observer, near-eye display system 10A further comprises a variable-compensation lens 52 of variable optical power. The variable compensation lens is configured to vary, responsive to a compensation bias from display controller 22, the vergence of the external light received into the optical waveguide. In some examples, the maximum optical power of the variable-focus lens opposes and substantially reverses the optical power of the fixed-focus lens, and the minimum optical power of the variable-compensation lens opposes and substantially reverses the optical power of the fixed-compensation lens.

When controlling the focusing bias such that the display light is imaged onto a focal plane positioned at a controlled, variable distance from observer O, display controller 22 may also synchronously control the compensation bias such that the external light from opposite the observer is released from optical waveguide 24 with unchanged vergence—i.e., the same vergence at which it was received. In some examples, the display controller is configured to control the focusing bias and compensation bias such that the vergence of the external light is varied in substantially equal and opposite amounts by variable-focus lens 38 and variable-compensation lens 52.

Variable-compensation lens 52 may be analogous in every respect to variable-focus lens 38, including structure, operation, and non-idealities (e.g., the dependence of aperture size on optical power). Accordingly, near-eye display system 10A may also include a fixed-compensation lens 54 arranged in series with variable-compensation lens 52 and configured to adjust the vergence of the external light received into optical waveguide 24.

In the configuration of FIG. 2A, variable-compensation lens 52 is positioned between fixed-compensation lens 54 and optical waveguide 24, for ease of manufacture. In other examples, the fixed-compensation lens may be positioned between the variable-compensation lens and the optical waveguide. In some examples, the fixed optical power of fixed-compensation lens 54 may oppose and substantially reverse the fixed optical power of fixed-focus lens 50.

In some examples, the optical power of fixed-compensation lens 54 may be related to the range of optical power of variable-compensation lens 52 in the same way indicated for fixed-focus lens 50 and variable-focus lens 38. For instance, in examples in which the variable optical power of the variable-focus lens varies within a non-divergent, non-negative diopter range as a function of the focusing bias, the variable optical power of the variable-compensation lens may vary within a non-convergent, non-positive diopter range as a function of the compensation bias. In examples in which the optical power of the variable-focus lens at a maximum value of the non-negative diopter range reverses the optical power of the fixed-focus lens, the optical power of the variable-compensation lens at the (algebraic) minimum value of the non-positive diopter range may reverse the optical power of the fixed-compensation lens. In examples in which the variable optical power of the variable-focus lens varies from a divergent, negative diopter value to a convergent, positive diopter value as a function of the focusing bias, the variable optical power of the variable-compensation lens may vary from a convergent, positive diopter value to a divergent, negative diopter value as a function of the compensation bias. Further, just as the fixed-focus lens may be a polymerized LC lens, the fixed-compensation lens may also be a polymerized LC lens.

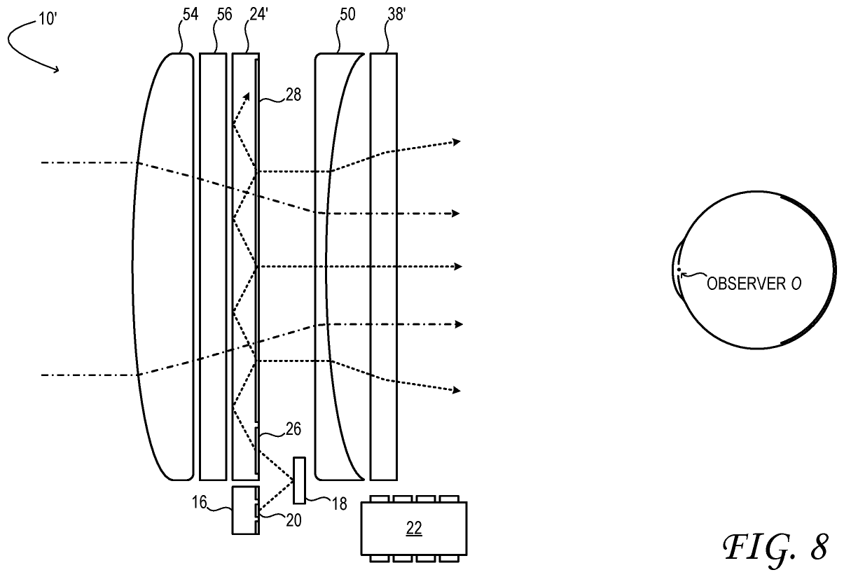

Despite the advantages of direct complementarity of the focusing and compensation stages of near-eye display system 10A, other configurations are also envisaged. FIG. 8 shows aspects of an example near-eye display system 10′ that eliminates variable-compensation lens 52 by coercing the display and external light into orthogonal polarization channels.

Near-eye display system 10′ includes a display projector 16′ configured to emit polarized display light, a polarization-maintaining optical waveguide 24′, and a polarization-selective variable-focus lens 38′. In this configuration, display light is released from the optical waveguide polarized in a given orientation. The variable-focus lens is configured to vary selectively the vergence of only the light polarized in the given orientation, but to maintain the vergence of light polarized perpendicular (i.e., transverse) to the given orientation. Near-eye display system 10′ includes a polarization filter 56 arranged to transmit external light polarized perpendicular to the given orientation from opposite the observer. In this configuration, optical waveguide 24′ receives the external light from the polarization filter and releases the external light toward the observer. Downstream of the optical waveguide, the vergence of the external light is altered only by fixed-focus lens 50, if such a lens is included. When the fixed-focus lens is included, its effect on the vergence of the external light may be compensated (e.g., reversed) by fixed-compensation lens 54.

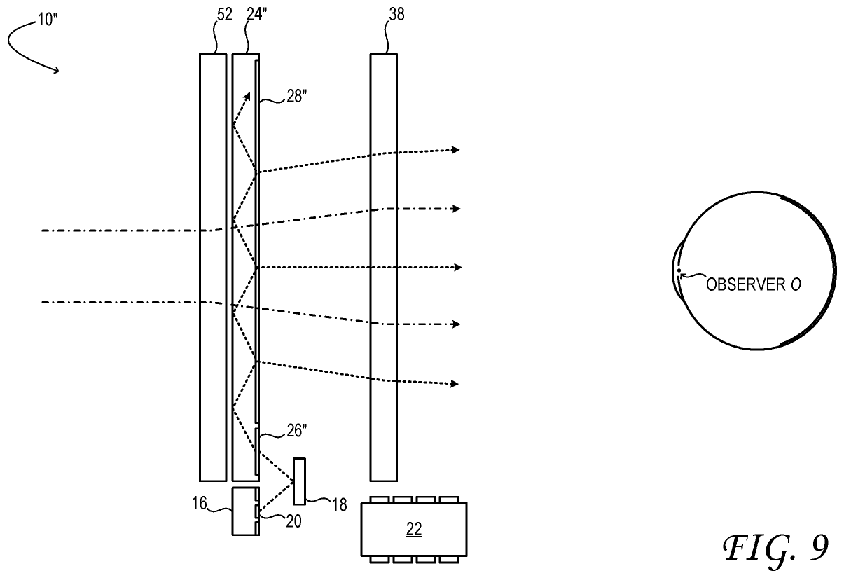

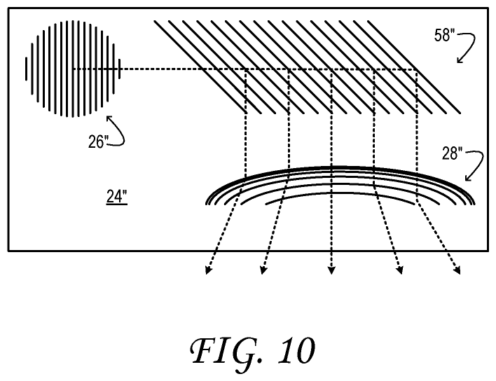

FIG. 9 shows aspects of an example near-eye display system 10″, in which the optical power of fixed-focus lens 50 is incorporated into optical waveguide 24″. In this configuration, fixed-compensation lens 54 is eliminated.

Optical waveguide 24″ of near-eye display system 10″ includes an entry grating 26″ and an exit grating 28″ from which the display light is released. As shown schematically in the plan view of FIG. 10, the optical waveguide also includes a turning grating 58″. In this example, fixed-focus lens 50 takes the form of a binary diffractive Fresnel lens formed on the exit grating. In a state-of-the-art optical waveguide exit grating, the grating orientation and pitch are fixed, and the etching depth is modulated to achieve uniform light intensity over the exit pupil. However, by modulating the grating orientations and pitch of exit grating 28″, it is possible to imprint the off-axis portion of a binary diffractive Fresnel lens on the exit grating, to replace fixed-compensation lens 54. In this configuration, all layers of the optical system may lay flat.

In the example of FIGS. 9 and 10, as in the previous configurations, variable-focus lens 38 is configured to vary, responsive to a focusing bias, a vergence of the display light and of the external light released from optical waveguide 24; variable-compensation lens 52 of variable optical power is configured to vary, responsive to a compensation bias, the vergence of the external light received into the optical waveguide. However, fixed-focus lens 50, being formed within the output grating of the waveguide, acts only on the light propagating through the optical waveguide (by TIR) and not on the light transmitted through it, so fixed-compensation lens 54 is not required. In other words, only the optical power imparted by variable-focus lens 38 need be compensated.

In near-eye display system 10″, the angle at which the display light couples into optical waveguide 24″ is determined by the configuration of entry grating 26″, and the angle at which the display light couples out of the optical waveguide is determined by the configuration of exit grating 28″. As both angles are sensitive functions of wavelength, any mismatch in the pitch, for example, of the entry and exit gratings may result in unwanted spectral dispersion and lateral pixel smear. These chromatic aberrations would be observed even from an unpowered exit grating. When the exit grating is configured as a diffractive Fresnel lens, however, its structure cannot be matched to that of the entry grating, and so the chromatic aberrations are exacerbated.

One way to overcome this issue is to ensure that optical waveguide 24″ carries substantially monochromatic display light. Accordingly, display projector 16 of near-eye display system 10″ may include one or more diode lasers in lieu of LED emitters, to limit the wavelength impurity of the display light coupled into the waveguide. In examples in which polychromatic display is desired, the optical waveguide may include a plurality of entry gratings (e.g., one each configured to diffract red, green, and blue light) and a corresponding plurality of exit gratings. In other examples, the near-eye display system may include a stack of optical waveguides each receiving and releasing only a single color of display light.

In still other examples, a compromise approach may be used to limit chromatic aberrations to an acceptable (e.g., substantially unnoticeable) level in color display implementations, but without necessary requiring three independent optical waveguides. In particular, a first optical waveguide may be used to carry the longer (e.g., red to green) wavelengths, and a second, optical waveguide may be used to carry the shorter (e.g., green to blue) wavelengths. For each optical waveguide, the applied optical power of exit grating 28″ is subject to some wavelength dispersion, but since the wavelength range is restricted, so too is the wavelength dispersion. In one, nonlimiting example, the first optical waveguide may suffer a dispersion of 0.1 D from red to green, and the second optical waveguide may suffer a dispersion of 0.1 D from green to blue. If the exit gratings of the first and second optical waveguides are configured to provide substantially the same power shift of −2.4 D to green light, then the blue light will be further diverged to −2.5 D, and the red light will be shifted only by −2.3 D. Chromatic aberration at the this low level is unlikely to be noticed by the observer.

No aspect of the foregoing drawings or description should be interpreted in a limiting sense, because numerous variations, extensions, and omissions are also envisaged. For instance, optical waveguide 24 is described above as having an entry grating through which display light is received and an exit grating through which the display light is released. Individually, each grating structure may offer the desired diffractive coupling to a narrow wavelength band of display light, consistent with monochromatic near-eye display applications. For polychromatic (i.e., color) display applications, the entry and exit gratings may be carefully matched in order to limit chromatic aberrations, as discussed above. Alternatively, in-coupling and out-coupling to the optical waveguide may be provided via non-diffractive (e.g., refractive, reflective, and/or scattering) optical features compatible with color display. In other examples in which polychromatic display is desired, the optical waveguide may include a plurality of entry gratings (e.g., one each configured to diffract red, green, and blue light) and a corresponding plurality of exit gratings. In still other examples, the near-eye display system may include a stack of optical waveguides each receiving and releasing only a single color of display light.

FIG. 11 is provided in order to illustrate, somewhat schematically, how the observer's pupil positions may be sensed in near-eye display system 10A. This approach may be used in implementations in which the most accurate 3D rendering is desired, or to provide automatic calibration of the near-eye display system for a range of different users, or to compensate for error in positioning wearable electronic device 12 on the user's head.

The configuration illustrated in FIG. 11 includes, for each near-eye display system or right/left portion thereof, a camera 60, an on-axis lamp 61A and an off-axis lamp 61B. Each lamp may comprise a light-emitting diode (LED) or diode laser, for example, which emits infrared (IR) or near-infrared (NIR) illumination in a high-sensitivity wavelength band of the camera.

The terms ‘on-axis’ and ‘off-axis’ refer to the direction of illumination of the eye with respect to the optical axis A of camera 60. As shown in FIG. 11, off-axis illumination may create a specular glint 62 that reflects from the observer's cornea 64. Off-axis illumination may also be used to illuminate the eye for a ‘dark pupil’ effect, where pupil 66 appears darker than the surrounding iris 68. By contrast, on-axis illumination from an IR or NIR source may be used to create a ‘bright pupil’ effect, where the pupil appears brighter than the surrounding iris. More specifically, IR or NIR illumination from on-axis lamp 61A may illuminate the retroreflective tissue of the retina 70, which reflects the illumination back through the pupil, forming a bright image 72 of the pupil. Image data from the camera is conveyed to associated logic of display controller 22. There, the image data may be processed to resolve such features as one or more glints from the cornea, or the pupil outline. The locations of such features in the image data may be used as input parameters in a model—e.g., a polynomial model—that relates feature position to the apparent center of the pupil.

The above description should not be understood as limiting in any sense, because pupil position may be determined, estimated, or predicted in various other ways. In one example, an electrooculographic sensor may be employed. In other examples, it may be sufficient to determine the location of the observer's eyes or head—e.g., by skeletal tracking, as noted above.

This disclosure is presented by way of example and with reference to the drawing figures described above. Components, process steps, and other elements that may be substantially the same in one or more of the figures are identified coordinately and are described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

One aspect of this disclosure is directed to a near-eye display system comprising a display projector configured to emit display light, an optical waveguide, a fixed-focus lens, and a variable-focus lens of variable optical power. The optical waveguide is configured to receive the display light and to release the display light toward an observer. The fixed-focus lens is arranged to adjust a vergence of the display light released from the optical waveguide. The variable-focus lens is arranged in series with the fixed-focus lens and configured to vary, responsive to a focusing bias, the vergence of the display light released from the optical waveguide.

In some implementations, the near-eye display system further comprises a controller configured to control the focusing bias such that the display light is imaged onto a focal plane positioned at a controlled, variable distance from the observer. In some implementations, the optical waveguide is further configured to receive external light from opposite the observer and to release the external light toward the observer, the near-eye display system further comprising a variable-compensation lens of variable optical power configured to vary, responsive to a compensation bias from the controller, the vergence of the external light received into the optical waveguide. In some implementations, the controller is configured to control the focusing bias and the compensation bias such that the vergence of the external light is varied in substantially equal and opposite amounts by the variable-focus and variable-compensation lenses. In some implementations, the fixed-focus lens is arranged to adjust the vergence of the external light received from opposite the observer. In some implementations, the near-eye display system further comprises a fixed-compensation lens arranged in series with the variable-compensation lens and configured to adjust the vergence of the external light received into the optical waveguide. In some implementations, an optical power of the fixed-compensation lens opposes and substantially reverses an optical power of the fixed-focus lens. In some implementations, the optical waveguide includes an exit grating from which the display light is released, and the fixed-focus lens is a diffractive Fresnel lens formed on the exit grating. In some implementations, the variable optical power of the variable-focus lens varies within a non-divergent, non-negative diopter range as a function of the focusing bias. In some implementations, the optical power of the variable-focus lens at a maximum value of the non-negative diopter range opposes and substantially reverses the optical power of the fixed-focus lens. In some implementations, the variable optical power of the variable-focus lens varies from a divergent, negative diopter value to a convergent, positive diopter value as a function of the focusing bias. In some implementations, the variable-focus lens is positioned between the fixed-focus lens and the optical waveguide. In some implementations, the fixed-focus lens is a polymerized liquid-crystal lens. In some implementations, the display light is released from the optical waveguide polarized in a given orientation, and the variable-focus lens is configured to vary selectively the vergence of light polarized in the given orientation, the near-eye display system further comprising a polarization filter arranged to transmit external light polarized perpendicular to the given orientation from opposite the observer, the optical waveguide being further configured to receive the external light from the polarization filter and to release the external light toward the observer.

Another aspect of this disclosure is directed to a near-eye display system comprising a display projector configured to emit display light, an optical waveguide, a fixed-focus lens, a variable-focus lens of variable optical power, a fixed-compensation lens, and a variable-compensation lens of variable optical power. The optical waveguide is configured to receive the display light from the display projector, to release the display light toward an observer, to receive external light from opposite the observer, and to release the external light toward the observer. The fixed-focus lens is arranged to adjust a vergence of the display light and of the external light released from the optical waveguide. The variable-focus lens is arranged in series with the fixed-focus lens and configured to vary, responsive to a focusing bias, the vergence of the display light and of the external light released from the optical waveguide. The fixed-compensation lens is arranged to adjust the vergence of the external light received into the optical waveguide. The variable-compensation lens is arranged in series with the fixed-compensation lens and configured to vary, responsive to a compensation bias, the vergence of the external light received into the optical waveguide.

In some implementations, the near-eye display system further comprises a controller configured to control the focusing bias such that the display light is imaged onto a focal plane positioned at a controlled, variable distance from the observer, and to synchronously control the compensation bias such that the external light from opposite the observer is released from the optical waveguide with unchanged vergence. In some implementations, the variable-compensation lens is positioned between the fixed-compensation lens and the optical waveguide. In some implementations, a maximum optical power of the variable-focus lens opposes and substantially reverses the optical power of the fixed-focus lens, and a minimum optical power of the variable-compensation lens opposes and substantially reverses the optical power of the fixed-compensation lens.

Another aspect of this disclosure is directed to a near-eye display system comprising a display projector configured to emit display light, an optical waveguide, a variable-focus lens of variable optical power, and a variable-compensation lens of variable optical power. The optical waveguide includes an exit grating incorporating a diffractive Fresnel lens and is configured to receive the display light from the display projector, to release the display light toward the observer via the exit grating, to receive the external light from opposite the observer, and to release the external light toward the observer. The variable-focus lens is configured to vary, responsive to a focusing bias, a vergence of the display light and of the external light released from the optical waveguide. The variable-compensation lens is configured to vary, responsive to a compensation bias, the vergence of the external light received into the optical waveguide. In some implementations, the display projector includes at least one laser.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A near-eye display system comprising:
a display projector configured to emit display light;
an optical waveguide configured to receive the display light and to release the display light toward an observer;
a fixed-focus lens arranged to adjust a vergence of the display light released from the optical waveguide; and
a variable-focus lens of variable optical power arranged in series with the fixed-focus lens and configured to vary, responsive to a focusing bias, the vergence of the display light released from the optical waveguide.

2. The near-eye display system of claim 1 further comprising a controller configured to control the focusing bias such that the display light is imaged onto a focal plane positioned at a controlled, variable distance from the observer.

3. The near-eye display system of claim 2 wherein the optical waveguide is further configured to receive external light from opposite the observer and to release the external light toward the observer, the near-eye display system further comprising a variable-compensation lens of variable optical power configured to vary, responsive to a compensation bias from the controller, the vergence of the external light received into the optical waveguide.

4. The near-eye display system of claim 3 wherein the controller is configured to control the focusing bias and the compensation bias such that the vergence of the external light is varied in substantially equal and opposite amounts by the variable-focus and variable-compensation lenses.

5. The near-eye display system of claim 3 wherein the fixed-focus lens is arranged to adjust the vergence of the external light received from opposite the observer.

6. The near-eye display system of claim 3 further comprising a fixed-compensation lens arranged in series with the variable-compensation lens and configured to adjust the vergence of the external light received into the optical waveguide.

7. The near-eye display system of claim 3 wherein an optical power of the fixed-compensation lens opposes and substantially reverses an optical power of the fixed-focus lens.

8. The near-eye display system of claim 1 wherein the optical waveguide includes an exit grating from which the display light is released, and wherein the fixed-focus lens is a diffractive Fresnel lens formed on the exit grating.

9. The near-eye display system of claim 1 wherein the variable optical power of the variable-focus lens varies within a non-divergent, non-negative diopter range as a function of the focusing bias.

10. The near-eye display system of claim 9 wherein the optical power of the variable-focus lens at a maximum value of the non-negative diopter range opposes and substantially reverses the optical power of the fixed-focus lens.

11. The near-eye display system of claim 1 wherein the variable optical power of the variable-focus lens varies from a divergent, negative diopter value to a convergent, positive diopter value as a function of the focusing bias.

12. The near-eye display system of claim 1 wherein the variable-focus lens is positioned between the fixed-focus lens and the optical waveguide.

13. The near-eye display system of claim 1 wherein the fixed-focus lens is a polymerized liquid-crystal lens.

14. The near-eye display system of claim 1 wherein the display light is released from the optical waveguide polarized in a given orientation, and wherein the variable-focus lens is configured to vary selectively the vergence of light polarized in the given orientation, the near-eye display system further comprising a polarization filter arranged to transmit external light polarized perpendicular to the given orientation from opposite the observer, the optical waveguide being further configured to receive the external light from the polarization filter and to release the external light toward the observer.

15. A near-eye display system comprising:
a display projector configured to emit display light;
an optical waveguide configured to receive the display light from the display projector, to release the display light toward an observer, to receive external light from opposite the observer, and to release the external light toward the observer;
a fixed-focus lens arranged to adjust a vergence of the display light and of the external light released from the optical waveguide;
a variable-focus lens of variable optical power arranged in series with the fixed-focus lens and configured to vary, responsive to a focusing bias, the vergence of the display light and of the external light released from the optical waveguide;
a fixed-compensation lens arranged to adjust the vergence of the external light received into the optical waveguide; and
a variable-compensation lens of variable optical power arranged in series with the fixed-compensation lens and configured to vary, responsive to a compensation bias, the vergence of the external light received into the optical waveguide.

16. The near-eye display system of claim 15 further comprising a controller configured to control the focusing bias such that the display light is imaged onto a focal plane positioned at a controlled, variable distance from the observer, and to synchronously control the compensation bias such that the external light from opposite the observer is released from the optical waveguide with unchanged vergence.

17. The near-eye display system of claim 15 wherein the variable-compensation lens is positioned between the fixed-compensation lens and the optical waveguide.

18. The near-eye display system of claim 15 wherein a maximum optical power of the variable-focus lens opposes and substantially reverses the optical power of the fixed-focus lens, and wherein a minimum optical power of the variable-compensation lens opposes and substantially reverses the optical power of the fixed-compensation lens.

19. A near-eye display system comprising:
a display projector configured to emit display light;
an optical waveguide including an exit grating incorporating a diffractive Fresnel lens, the optical waveguide being configured to receive the display light from the display projector, to release the display light toward the observer via the exit grating, to receive the external light from opposite the observer, and to release the external light toward the observer;
a variable-focus lens of variable optical power configured to vary, responsive to a focusing bias, a vergence of the display light and of the external light released from the optical waveguide; and
a variable-compensation lens of variable optical power configured to vary, responsive to a compensation bias, the vergence of the external light received into the optical waveguide.

20. The near-eye display system of claim 19 wherein the display projector includes at least one laser.
